(19) United States
(12) Patent Application Publication
(10) Pub. No.: US 2024/0202459 A1
(43) Pub. Date: Jun. 20, 2024

(54) INCREASING EXPLAINABILITY OF DISCOURSE

(71) Applicant: INTERNATIONAL BUSINESS MACHINES CORPORATION, ARMONK, NY (US)

(72) Inventors: Kelley Anders, East New Market, MD (US); Jonathan D. Dunne, Dungarvan (IE); Qi Li, Beijing (CN)

(21) Appl. No.: 18/067,937

(22) Filed: Dec. 19, 2022

(51) Int. Cl. G06F 40/40; G06F 16/332

(52) U.S. Cl. CPC G06F 40/40; G06F 16/3329

(57) ABSTRACT

According to one embodiment, a method, computer system, and computer program product for explaining discourse is provided. The embodiment may include identifying one or more skill levels for one or more users. The embodiment may also include identifying a complexity level corresponding to a piece of content. The embodiment may further include determining an explanation level for the piece of content based on the complexity level of the piece of content and a target skill level from the one or more skill levels. The embodiment may also include generating an explanation for the piece of content according to the explanation level. The embodiment may further include providing the explanation to a target user.

### BACKGROUND

The present invention relates generally to the field of computing, and more particularly to natural language processing.

Natural language processing is a field of computing that enables computers to process, translate, and practically understand natural language. As opposed to languages and formats designed or encoded for computers to understand, such as programming languages, markup languages, and databases, natural language is the type ordinarily used for communication between humans, and thus requires computing techniques such as lexical analysis artificial intelligence and machine learning to process. However, these methods enable computers to simplify user interfaces and interact with text not written specifically for computers to interact with.

Natural language processing may be useful in the context of discourse, helping moderate a public forum, social network, or chat service. However, current solutions may use simple methods of lexical analysis to superficially gauge foul language, sentiment, or dishonesty, rather than deeply understand the complexity and explainability of discourse in context. This shallow analysis may limit the ability of traditional natural language processing techniques to resolve misunderstandings or help to avoid an argument.

### SUMMARY

According to one embodiment, a method, computer system, and computer program product for explaining discourse is provided. The embodiment may include identifying one or more skill levels for one or more users. The embodiment may also include identifying a complexity level corresponding to a piece of content. The embodiment may further include determining an explanation level for the piece of content based on the complexity level of the piece of content and a target skill level from the one or more skill levels. The embodiment may also include generating an explanation for the piece of content according to the explanation level. The embodiment may further include providing the explanation to a target user.

In a preferred embodiment, determining an explanation level further includes determining an explainability of the piece of content based on the complexity level of the piece of content.

In a preferred embodiment, the content may comprise a message in a chat service.

In a preferred embodiment, the method further includes identifying the complexity level is performed using natural language processing.

In a preferred embodiment, the target skill level and the complexity level each correspond to a particular subject.

In a preferred embodiment, generating an explanation further includes selecting an explanation from a preexisting repository of explanations.

In a preferred embodiment, generating an explanation further includes natural language generation.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for explaining discourse dynamically according to user skill levels.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to natural language processing. The following described exemplary embodiments provide a system, method, and program product to, among other things, explain discourse to users with various skill levels. Therefore, the present embodiment has the capacity to improve the technical field of natural language processing by assessing explainability of complex discourse to aide user understanding based on user skill level.

As previously described, natural language processing is a field of computing that enables computers to process, translate, and practically understand natural language. As opposed to languages and formats designed or encoded for computers to understand, such as programming languages, markup languages, and databases, natural language is the type ordinarily used for communication between humans, and thus requires computing techniques such as lexical analysis, artificial intelligence and machine learning to process. However, these methods enable computers to simplify user interfaces and interact with text not written specifically for computers to interact with.

Natural language processing may be useful in the context of discourse, helping moderate a public forum, social network, or chat service. However, current solutions may use simple methods of lexical analysis to superficially gauge foul language, sentiment, or dishonesty, rather than deeply understand the complexity and explainability of discourse in context. As such, it may be advantageous to, among other things, assess complexity and explainability of complex discourse to aide user understanding based on user skill level.

According to one embodiment, a method for explaining discourse to users is provided. One or more users may be classified according to skill level, and a piece of content, such as a post, comment, or message, may be classified according to a level of complexity. A discourse complexity to explainability function may then be used to determine an explanation level for the content based on the complexity of the content and the skill level of one or more users. An explanation may then be generated according to the explanation level and provided to the relevant users.

One or more embodiments described above may convey the advantage of providing unique insights for natural language processing, allowing for explanations to be more relevant, helpful, or meaningful.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

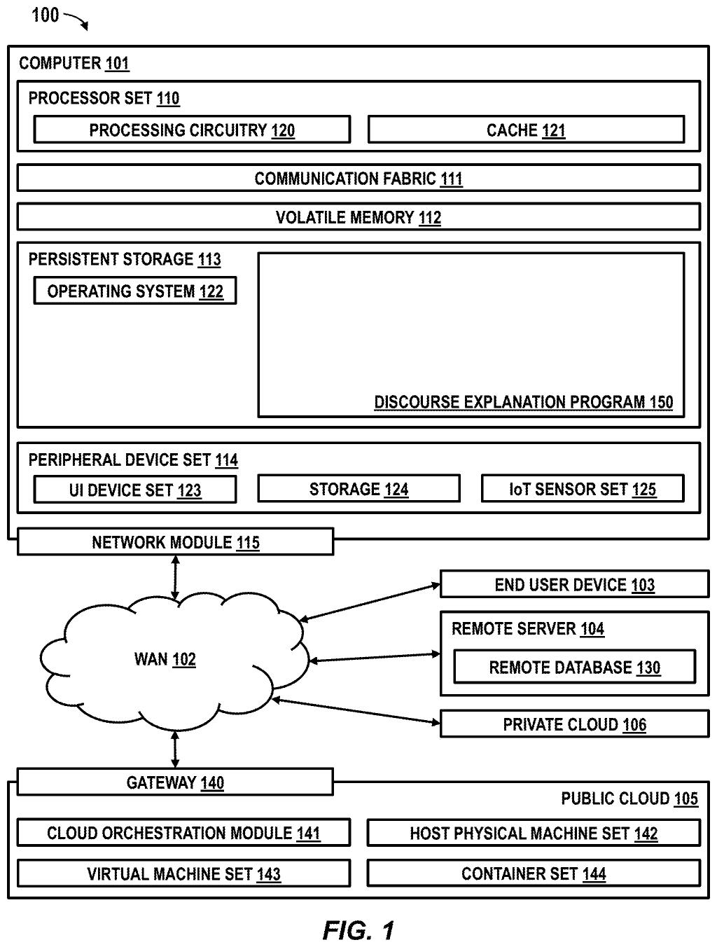

Referring now to FIG. 1, computing environment 100 contains an example of an environment for the execution of at least some of the computer code involved in performing the inventive methods, such as discourse explanation program 150. In addition to discourse explanation program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and discourse explanation program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in discourse explanation program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in discourse explanation program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The discourse explanation program 150 may identify a skill level of one or more users and a complexity level of a piece of content. The skill level of each user and complexity level may then be used to measure explainability and determine one or more explanation levels for the content. An explanation for the content may be generated and provided to the relevant users according to the explanation levels.

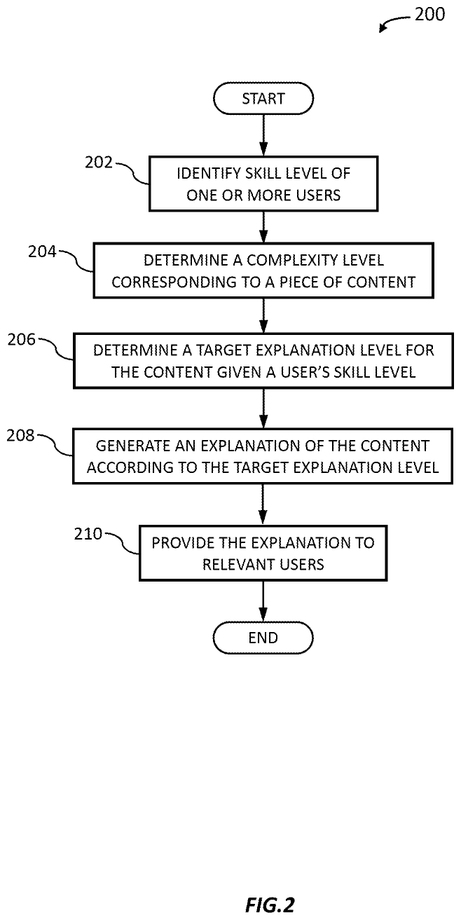

Furthermore, notwithstanding depiction in computer 101, discourse explanation program 150 may be stored in and/or executed by, individually or in any combination, end user device 103, remote server 104, public cloud 105, and private cloud 106. The discourse explanation method is explained in more detail below with respect to FIG. 2.

Referring now to FIG. 2, an operational flowchart for a process for explaining discourse according to complexity and skill 200 is depicted according to at least one embodiment. At 202, the discourse explanation program 150 identifies a skill level of one or more users. A skill level may include an overall skill level or skill levels corresponding to one or more subjects. Skill levels may be determined manually, using natural language processing techniques, using external measures of skill such as certifications, or using a combination of these methods. A user may be, for example, a chat participant, forum user, social media user, administrative user, or viewer of a presentation.

A skill level may include an overall skill level, multiple skill levels corresponding to particular fields, or a combination of each. For example, a skill level may correspond to a user's overall education level, to education levels in specific fields, such as computer science, mathematics, and English, to the set of each of these education levels, or to a composite of overall education in light of all of these fields. An education level may correspond to formal education, certifications, or any other measurement of education level.

In at least one embodiment, skill levels may be determined manually. A user may self-identify or self-select a skill level. A user may select a level of skill that the user identifies with, or a level of skill corresponding to a target explanation level the user would like to see. For example, a sophisticated user who prefers to see low-level explanations may select a low skill level. Alternatively, a user may select “French” as a native language for a “Native Speaker” skill level and may select “English” as a secondary language for a “Secondary Language” skill level. Alternatively, a user's skill level may be determined by a user's manager, teacher, or professor, or a moderator or administrator on a social network, internet forum, or messaging service.

In at least one embodiment, skill levels may be determined using natural language processing techniques. Natural processing techniques may rate skill levels for a user based on messages, comments, or posts from the user, other writings or speech from the user, or writings or speech directed at or otherwise corresponding to the user, where writings and speech are collected according to opt-in procedures. Natural language processing may include use of speech-to-text or text-to-speech processing. The discourse explanation program 150 may further use techniques such as image recognition to convert text elements in an image to a format that can be used in natural language processing.

Natural language processing techniques may include quantitative techniques such as word length, word frequency, word difficulty, sentence length, text length, measures of text cohesion, and measures of the use of photographs, videos, citations, links, and emoticons. For example, a database may include a list of words graded by difficulty, and skill level may be determined, in full or in part, based on an average or weighted average word difficulty of the words used by a user overall, or in a given period of time. Alternatively, the discourse explanation program 150 may determine that, for example, in chat-based conversations relating to the subject of economics, long message length and short sentence length in the context of long messages correspond to higher skill levels.

Natural language processing techniques may further include qualitative techniques, including Lexile® (Lexile and all Lexile-based trademarks and logos are trademarks or registered trademarks of Measures MetaMetrics, Inc. and/or its affiliates), content topic modeling, or corpus linguistics techniques, including Latent Dirichlet Analysis, cosine similarity, Jaccard distance, and IBM Watson® Natural Language Understanding services (IBM Watson and all IBM Watson-based trademarks and logos are trademarks or registered trademarks of International Business Machines Corporation and/or its affiliates). Quantitative techniques may be used to ascertain concepts, entities, and keywords. For example, cosine similarity may be used to determine the similarity between the topics of two conversations, and whether the conversations reflect skill in the same subject. Further, if the skill level of one user in that subject is known, cosine similarity may be used to indicate a likelihood that another user of unknown skill level has a similar skill level to the first user.

Natural language processing techniques may further include the use of artificial intelligence techniques, including natural language understanding, machine learning, and use of neural networks. Machine learning techniques may use a knowledge base composed of messages, posts, or comments, information from profiles regarding users, or any other information collected according to an opt-in procedure. For example, a neural network utilizing Long Short-Term Memory may determine a user's skill level based on a series of messages over time with timestamps. Machine learning may include use of user feedback obtained regarding explanations provided to users at 210.

In at least one embodiment, identifying a skill level may be performed using external sources of skill ratings. External sources of skill ratings may include qualifications, credits, certifications, degrees, and other information profiling users obtained using an opt-in procedure. Skill ratings may be collected from internet sources, including application programming interfaces (APIs), user social media profiles, such as a LinkedIn® profile (LinkedIn and all LinkedIn-based trademarks and logos are trademarks or registered trademarks of LinkedIn Corporation and/or its affiliates), user resumes, or transcript documents that may reflect user skills.

In an alternate embodiment, the discourse explanation program 150 may ascertain a skill level based, in whole or in part, on other factors, including, for example, a computer vision analysis of images or videos shared by a user, the number of users who appear to ask a user for assistance, or based on feedback from other users. A user's skill level may be assessed and re-assessed any number of times, at any frequency, continuously, or in response to any change in any of the above factors.

The discourse explanation program 150 may identify skill levels of users according to any combination of the above methods. Each user and each skill level may be identified by any combination of methods, and different users or different skills may be measured according to different methods. A skill level may be determined for a group of users, collectively, such as a class of students receiving a presentation. The discourse explanation program 150 may further utilize methods of identifying a complexity level at 204 to determine a skill level of a user.

A skill level may be decided on a numerical scale or a scale with named ranks, such as “Ph.D. Level Skill” and “Masters' Degree Level Skill.” A scale for skill levels may be predetermined or may be generated dynamically by discourse explanation program 150 as more skill levels are needed to adequately represent the skill levels of users.

Then, at 204, the discourse explanation program 150 identifies a complexity level corresponding to a piece of content. A piece of content may include, for example, for a chat message, forum comment, social media post, a presentation slide. Complexity may reflect the difficulty of understanding a piece of content or the level of skill necessary to understand the content at a certain level of comprehension. A complexity level may include an overall complexity level or a series of complexity levels in each of one or more subjects. A complexity level may be determined manually, based on the skill level of the user who created the content, based on natural language processing techniques, using feedback from other users, or using a combination of these methods.

In at least one embodiment, a piece of content may include, for example, for a chat message, forum comment, social media post, a presentation slide, or any other text, audio, image-based, or video-based content that may warrant explanation. A piece of content may further include multiple smaller pieces of content that are related by, for example, a theme, subject, or complexity level. For example, a piece of content may include a series of messages from one or more users, or a full conversation thread on a web forum.

A complexity level may include an overall complexity level, a series of complexity levels in each of one or more subjects, or a combination or composite of each. In one instance, an overall complexity level may correspond to the highest complexity level in any one particular subject. Alternatively, an overall complexity level may correspond to a complexity level in a main subject, or an average complexity level in one or more major subjects.

In at least one embodiment, a complexity level may be identified manually. For example, a complexity level of a comment may be identified by the user who wrote the comment. Alternatively, the complexity level of a post on a web forum may be determined by a moderator of the web forum. As yet another alternative, a complexity level of an educational presentation may be determined by a teacher for a class receiving the presentation.

In another embodiment, a complexity level for a piece of content may be determined according to the skill level of the person who created the content. For example, if Anna writes a post about quantum computing, the complexity level of the post may be set according to or determined in light of Anna's skill level in the subject of quantum computing.

In a further embodiment, a complexity level may be determined using natural language processing techniques. Natural language processing may include use of speech-to-text or text-to-speech processing. The discourse explanation program 150 may further use techniques such as image recognition to convert text elements in an image to a format that can be used in natural language processing.

Natural language processing techniques may include quantitative techniques such as word length, word frequency, word difficulty, sentence length, text length, measures of text cohesion, and measures of the use of photographs, videos, citations, links, and emoticons. For example, a database may include a list of words graded by difficulty, and a complexity level may be determined, in full or in part, based on an average or weighted average word difficulty of the words used in the piece of content. Alternatively, the discourse explanation program 150 may determine that, for example, forum posts on the subject of deontological ethics may be considered more complex if they contain three or more citations. More specifically, a post's complexity level may simply be equal to the number of sources cited by the post.

Natural language processing techniques may further include qualitative techniques, including Lexile®, content topic modeling, or corpus linguistics techniques, including Latent Dirichlet Analysis, cosine similarity, Jaccard distance, and IBM Watson® Natural Language Understanding services. Quantitative techniques may be used to ascertain concepts, entities, and keywords. For example, Jaccard distance may be used to determine the similarity between the subjects of two posts on a social network, or whether two messages should be treated as part of a single piece of content. Further, if the complexity level of one piece of content is known, Jaccard distance may be used in determining the complexity level of a similar piece of content.

Natural language processing techniques may further include the use of artificial intelligence techniques, including natural language understanding, machine learning, and use of neural networks. Machine learning techniques may use a knowledge base composed of messages, posts, or comments, information from profiles regarding users, or any other information collected according to an opt-in procedure. Machine learning may include use of user feedback obtained regarding explanations provided to users at 210.

In another embodiment, the discourse explanation program 150 may ascertain a complexity level based on user feedback about a piece of content. For example, in a chat service with emoticon reactions and threaded comments, a complexity level may be set based on the number of reactions made using a “question mark” emoticon and the number of comments under the message thread that contain question marks. Alternatively, feedback for a piece of content may be obtained according to an explicit system asking users how they would rate the complexity of the content.

In an alternate embodiment, the discourse explanation program 150 may identify a complexity level based on a computer vision analysis of images or videos shared. For example, if a piece of content is a presentation slide containing text and an image, a computer vision analysis of the image may determine that the image contains a highly complex diagram of a computer motherboard.

A complexity level for a large piece of content may include or be a composite of complexity levels for one or more smaller pieces of content. For example, if a piece of content is a presentation slide containing text and an image, a complexity level for the slide may be the greater of the complexity levels of the text and of the image.

Complexity levels may be identified based on any combination of the above factors, and may be re-identified any number of times, continuously, or in response to any change in any of the above factors. For example, in a chat service with threaded comments, a complexity level may change based on a continuous natural language understanding of the sentiment of comments as they are made.

A complexity level may be decided on a numerical scale or a scale with named ranks, such as “Ph.D. Level Complexity” and “Masters' Degree Level Complexity.” A scale for complexity levels may be predetermined or may be generated dynamically by discourse explanation program 150 as needed to adequately represent the complexity of content.

Next, at 206, the discourse explanation program 150 determines a target explanation level for the content based on the complexity level of that content and a target skill level. Determining an explanation level may be determined using a discourse complexity to explainability function, which may include additional factors and may utilize additional techniques of natural language processing and artificial intelligence.

An explanation level may describe a level of clarity or accessibility desired for an explanation to be provided to one or more target users. An explanation level may correspond to a complexity of a desired explanation or to the target skill level.

A discourse complexity to explainability function may utilize the complexity of a piece of content, a target skill level for an explanation of the content to determine an explanation level for the content. The function may further take additional input, including a subject for the content, complexity level of a subject, information regarding users, or other information involving the intended explanation, such as an intended medium, language, or format for the explanation.

In at least one embodiment, the discourse complexity to explainability function may determine an explainability level or explanation level. An explainability level may be positively correlated to complexity, indicating that content is rich in complex information that may be explained thoroughly and simply, allowing a low level of explanation, or that simple content demands little explanation, satisfied by a high level of explanation. Alternatively, an explainability level may be negatively correlated to complexity, indicating that complex content is difficult to explain effectively, demanding a high level of explanation, or that simple content may be explained simply, satisfied by a low level of explanation. An explanation level may be determined relative to a complexity level. For example, an explanation level for a piece of content with a complexity level corresponding to “Ph.D. level complexity” may be set to two explanation levels below “Ph.D. level explanation,” or an explanation level for a piece of content with level 10 complexity may be set to a level 8 explanation.

The discourse complexity to explainability function may take further advantage of natural language processing in determining the explanation level. Natural language processing may include use of any of the quantitative or qualitative techniques described at 202 and 204. For example, the discourse explanation program 150 may use qualitative techniques to determine that a medium-complexity piece of content is long, and use qualitative techniques to determine that the content contains a high degree of redundancy and contains a high prevalence of words with simple, accurate synonyms, and may therefore be highly explainable, allowing for a low-level explanation. Alternatively, a qualitative technique may determine that a piece of content with high complexity is short, and qualitative techniques may determine that the subject is highly complex, and that content explains itself almost as simply or as accessibly as possible, and may determine that explainability is low. In such a case, the discourse explanation program 150 may, for example, determine a relative explanation level only one level below the complexity level of the content.

The discourse complexity to explainability function may further take advantage of artificial intelligence in determining the explanation level. Artificial intelligence may include techniques including natural language understanding, machine learning, and use of neural networks. Machine learning and neural networks may rely on feedback, such as feedback obtained at 204 or 210. For example, machine learning may determine that, if a level 6 explanation of level 10 content to a level 6 user results in feedback indicating a high degree of confusion, explainability for the content was not sufficient to create a level 6 explanation.

In an alternate embodiment, an explanation level may be determined as higher than the complexity level, indicating that a simple piece of content may be explained at a more advanced level for a highly skilled user.

In at least one embodiment, an explanation level may be determined relative to a single target user's skill level. Alternatively, an explanation level may be determined relative to the skill levels of a group of target users, or to a full audience. A group of target users may have a single skill level, or a composite skill level determined at 202. For example, in a presentation being given to three classes, an explanation level may be determined relative to a composite of the skill levels in each class, such as a weighted average skill level of individual students in the class.

In a further embodiment, an explanation level may further be determined for more than one subject in the content, or according to more than one skill level in more than one subject for one user. For example, a piece of content on the topic of quantum computing may be given one explanation level for a user with a skill level of 9 in quantum physics and a skill level of 10 in computer science, a different explanation level for a user with a skill level of 14 in quantum physics and a skill level of 14 in computer science, and a composite explanation level for a user with a skill level of 8 in quantum physics and 13 in computer science, where the composite explanation level indicates a low level of explanation for quantum physics issues and a high level of explanation for computer science issues.

Then, at 208, the discourse explanation program 150 generates one or more explanations for the content according to the explanation level. The discourse explanation program 150 may generate one explanation per explanation level, per user, per user group, or per context in which an explanation is to be presented at 210. An explanation level may describe a level of clarity or accessibility desired for an explanation to be provided to one or more target users. An explanation may be composed of natural language text, other text, audio, images, videos, or any other content format.

In at least one embodiment, an explanation may be a natural language text explanation. A natural language text explanation may be generated using natural language processing techniques such as natural language generation, or may modify an existing natural language text using natural processing techniques, including the original piece of content. Generating a natural text explanation may be performed using artificial intelligence, including a process of artificial intelligence utilizing machine learning or a neural network.

Natural language text explanations may be generated in or translated to any natural language depending on, for example, a language skill level of a user, or a language that is known to be useful in explaining content of the given subject.

Alternatively, a text explanation may be written in a code format, a logical format, a mathematical format, or another technical format. For example, if the explanation level for a simple piece of content is higher than the complexity level of the content, the explanation may use additional mathematical notation to provide additional insight to users with high skill levels.

In another embodiment, an explanation may include or be composed of audio, images, videos, or any other content format. For example, if a piece of content is available on a social network known for audio content, the discourse explanation program 150 may generate a natural language description of content in an audio format using natural language generation and a text-to-speech algorithm. Alternatively, a piece of content that includes text and images may be used to generate an infographic that draws connections between text and images. Video content may include an animated image format such as the Graphics Interchange Format (GIF), and may also include video with synchronized audio.

In yet another embodiment, generating an explanation may include obtaining an explanation from an external source of useful explanations, including a predetermined repository of explanatory text, an internet service with explanatory videos, a wiki or similar collective knowledge service, a question-and-answer website such as Stack Exchange® (Stack Exchange and all Stack Exchange-based trademarks and logos are trademarks or registered trademarks of Stack Exchange, Inc. and/or its affiliates), or a historical database of past explanations. Generating a text may include selecting, adapting, or translating a preexisting explanation obtained from an external source.

A format for an explanation may be selected to match the format of the content, such as a video explanation for video content. Alternatively, a format may be selected to contrast with the format of a content, such as an audio explanation of text content.

Alternatively, a format for an explanation may be selected as to best communicate the meaning of the content to a user. Determining the best format to communicate the meaning of content may include collecting a manually selected user preference or a determination based on user data collected according to opt-in procedures. For example, if a social media profile indicates that Bob enjoys video explanations of mathematical concepts, the discourse explanation program 150 may select video as an explanation format for an explanation intended for Bob. Alternatively, if Charlie's class has 30 minutes to review a topic, an explanation format may be determined to explain the subject efficiently given the time available.

Next, at 210, the discourse explanation program 150 provides the explanation to the relevant users. Providing an explanation may include displaying, playing, sending, or otherwise providing access to the explanation. The relevant users may be the users for whom the explanation level was determined or for whom explanation was generated.

In at least one embodiment, providing an explanation may include displaying the explanation over the content, near the content, or separately from the content. For example, an explanation may replace the content in a target user's web browser. An explanation in a web forum may be presented as a reply comment to a forum post, or in a sidebar next to the forum post. Alternatively, an explanation may appear as a separate window or overlay independent of the program displaying the content. An explanation during a web presentation may be displayed in the presentation window, or in another application. An explanation during an in-person presentation may be displayed using a projector or an overhead screen.

In the case of audio or video content, providing the explanation may include playing the audio or video, or providing an option for a user to play the audio or video, for example by hitting a play button.

Providing an explanation may further include sending the explanation to a user by a message in a chat service, an email, or a notification in an operating system's user messaging and notification system.

Providing an explanation may further include providing access to an explanation, such as by providing a Universal Resource Indicator (URI), or setting a secure flag on a user's account to allow access to an explanation.

In at least one embodiment, providing an explanation may include obtaining feedback regarding the explanation from a user. Feedback may indicate how simple, accessible, or clear an explanation is, whether an explanation is effective in communicating the meaning of the content, how accurate an explanation is, or any other qualitative or quantitative feedback about the explanation or how it is presented.

Feedback may be obtained, for example, by a graphical user interface requesting feedback from users; by elements of a user interface with which a user interacts, such as a reply option on a web forum, chat responses in a chatroom, or reactions on a social messaging service; or in an analog format, such as by collecting paper feedback forms from students in a classroom.

Feedback may be used in machine learning at any step above. Alternatively, feedback may be provided to a person, such as the person who created the content, a teacher for a class, a web forum moderator, a presenter in a web presentation, or a developer seeking to further improve the discourse explanation program 150.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying one or more skill levels for one or more users;
identifying a complexity level corresponding to a piece of content;
determining an explanation level for the piece of content based on the complexity level of the piece of content and a target skill level from the one or more skill levels;
generating an explanation for the piece of content according to the explanation level; and
providing the explanation to a target user.

2. The method of claim 1, wherein determining an explanation level further comprises:
determining an explainability of the piece of content based on the complexity level of the piece of content.

3. The method of claim 1, wherein the content comprises a message in a chat service.

4. The method of claim 1, wherein identifying the complexity level is performed using natural language processing.

5. The method of claim 1, wherein the target skill level and the complexity level each correspond to a particular subject.

6. The method of claim 1, wherein generating an explanation includes selecting an explanation from a preexisting repository of explanations.

7. The method of claim 1, wherein generating an explanation includes natural language generation.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying one or more skill levels for one or more users;
identifying a complexity level corresponding to a piece of content;
determining an explanation level for the piece of content based on the complexity level of the piece of content and a target skill level from the one or more skill levels;
generating an explanation for the piece of content according to the explanation level; and
providing the explanation to a target user.

9. The computer system of claim 8, wherein determining an explanation level further comprises:
determining an explainability of the piece of content based on the complexity level of the piece of content.

10. The computer system of claim 8, wherein the content comprises a message in a chat service.

11. The computer system of claim 8, wherein identifying the complexity level is performed using natural language processing.

12. The computer system of claim 8, wherein the target skill level and the complexity level each correspond to a particular subject.

13. The computer system of claim 8, wherein generating an explanation includes selecting an explanation from a preexisting repository of explanations.

14. The computer system of claim 8, wherein generating an explanation includes natural language generation.

15. A computer program product, the computer program product comprising:
one or more computer-readable tangible storage medium and program instructions stored on at least one of the one or more tangible storage medium, the program instructions executable by a processor capable of performing a method, the method comprising:
identifying one or more skill levels for one or more users;
identifying a complexity level corresponding to a piece of content;
determining an explanation level for the piece of content based on the complexity level of the piece of content and a target skill level from the one or more skill levels;
generating an explanation for the piece of content according to the explanation level; and
providing the explanation to a target user.

16. The computer program product of claim 15, wherein determining an explanation level further comprises:
determining an explainability of the piece of content based on the complexity level of the piece of content.

17. The computer program product of claim 15, wherein the content comprises a message in a chat servicer.

18. The computer program product of claim 15, wherein identifying the complexity level is performed using natural language processing.

19. The computer program product of claim 15, wherein the target skill level and the complexity level each correspond to a particular subject.

20. The computer program product of claim 15, wherein generating an explanation includes selecting an explanation from a preexisting repository of explanations.
